(19) United States
(12) Patent Application Publication
(10) Pub. No.: US 2026/0322593 A1
(43) Pub. Date: Oct. 15, 2026

(54) DISTRIBUTED HOMOMORPHIC ENCRYPTION PROTOCOL FOR CONFIDENTIAL COMPUTATION

(71) Applicant: Ava Labs, Inc., New York, NY (US)

(72) Inventors: Furkan Boyraz, Istanbul (TR); Mehmet Berat Öztürk, Istanbul (TR); Emre Kaan Satis, Istanbul (TR); Emin Gün Sirer, Ithaca, NY (US)

(21) Appl. No.: 19/643,352

(22) Filed: Apr. 9, 2026

Related U.S. Application Data
(60) Provisional application No. 63/786,382, filed on Apr. 10, 2025.

(51) Int. Cl. H04L 9/08; H04L 9/32

(52) U.S. Cl. CPC H04L 9/0838; H04L 9/0861; H04L 9/3247; H04L 2209/56

(57) ABSTRACT

Various aspects of the subject technology relate to systems and methods for performing confidential computation on encrypted data in a distributed ledger network. Aspects may include receiving, at a node of a plurality of nodes, a ciphertext representing transaction data encrypted under a network encryption public key and obtaining validator information from a shared registry maintained on the distributed ledger network. Aspects may further include performing, using the validator information, a cryptographic operation on the ciphertext to produce a result ciphertext, the cryptographic operation including at least one of a homomorphic operation or an interactive multiparty computation executed among the plurality of nodes. Aspects may further include executing a state transition within the distributed ledger network based on the result ciphertext and finalizing a transaction corresponding to the state transition.

### CROSS-REFERENCE TO RELATED APPLICATIONS

The present disclosure is related and claims priority under 35 U.S.C. § 119(e), to U.S. Provisional Patent Application No. 63/786,382, entitled CONFIDENTIAL SMART CONTRACT EXECUTION PROTOCOL, to Furkan Boyraz et al., filed on Apr. 10, 2025, the contents of which are hereby incorporated by reference in their entirety, for all purposes.

### TECHNICAL FIELD

The present disclosure generally relates to cryptographic systems for confidential computation in distributed networks, and more particularly to distributed homomorphic encryption protocols that combine fully homomorphic encryption, multiparty computation, and zero-knowledge proofs to enable secure computation on encrypted data within blockchain environments.

### BACKGROUND

Distributed computing systems and blockchain networks process and store data across multiple participants but face significant challenges in maintaining data confidentiality while enabling computation on encrypted data. Traditional encryption schemes protect data at rest and in transit but require decryption before computational operations can be performed, creating security vulnerabilities during processing. Fully homomorphic encryption schemes allow computation directly on encrypted data without decryption, but implementing such schemes in distributed environments presents substantial technical obstacles. Conventional fully homomorphic encryption approaches require computationally intensive bootstrapping operations to manage noise accumulation in ciphertexts, with single bootstrapping operations consuming significant processing time. Non-arithmetic operations such as comparisons, divisions, and conditional evaluations on encrypted data typically require polynomial approximation techniques that are computationally expensive and impractical for real-time applications.

In blockchain networks, maintaining confidentiality of transaction data and smart contract states while enabling validators to verify and execute operations presents unique challenges. Public blockchain systems typically provide only pseudonymity through public key addresses, exposing transaction amounts, account balances, and contract interactions to all network participants. This lack of confidentiality has limited adoption for applications requiring sensitive data management and confidential business operations.

### BRIEF SUMMARY

The subject disclosure provides systems and methods for performing confidential computation on encrypted data in a distributed ledger network. In particular, the disclosed techniques enable transaction data to be processed in encrypted form using distributed cryptographic operations performed across a plurality of nodes, thereby preserving data confidentiality while supporting verifiable state transitions on the distributed ledger and enabling confidential smart contract development obfuscating contract inputs and outputs.

According to embodiments, a computer-implemented method for performing confidential computation on encrypted data is provided. The method includes receiving, at a node of a plurality of nodes in a distributed ledger network, a ciphertext representing transaction data encrypted under a network encryption public key and obtaining validator information from a shared registry maintained on the distributed ledger network. The method further includes performing, using the validator information, a cryptographic operation on the ciphertext to produce a result ciphertext, wherein the cryptographic operation includes at least one of a homomorphic operation or an interactive multiparty computation executed among the plurality of nodes. The method further includes executing a state transition within the distributed ledger network based on the result ciphertext and finalizing a transaction corresponding to the state transition.

According to embodiments, a system is provided that includes one or more processors and a memory storing instructions which, when executed by the one or more processors, cause the system to perform operations for confidential computation on encrypted data in a distributed ledger network. The operations include receiving a ciphertext representing transaction data encrypted under a network encryption public key, obtaining validator information from a shared registry, performing a cryptographic operation on the ciphertext using the validator information to produce a result ciphertext, wherein the cryptographic operation comprises at least one of a homomorphic operation or an interactive multiparty computation executed among a plurality of nodes, and executing a state transition within the distributed ledger network based on the result ciphertext to finalize a corresponding transaction.

According to embodiments, a non-transitory computer-readable medium is provided that stores instructions for performing confidential computation on encrypted data in a distributed ledger network. The instructions, when executed by a computing device, cause the computing device to receive a ciphertext representing transaction data encrypted under a network encryption public key, obtain validator information from a shared registry, perform a cryptographic operation on the ciphertext to produce a result ciphertext using at least one of homomorphic computation or interactive multiparty computation among a plurality of nodes, and execute a state transition within the distributed ledger network based on the result ciphertext to finalize a transaction.

These and other embodiments will become apparent to those of ordinary skill in the art in view of the following detailed description.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a block diagram of a network architecture with which aspects of the present disclosure can be implemented.

FIG. 2 is a block diagram illustrating details of participants implementing Distributed Homomorphic Encryption (DHE) in the architecture of FIG. 1, according to certain aspects of the present disclosure.

FIG. 3 is a workflow diagram illustrating phases of a DHE protocol, according to certain aspects of the present disclosure.

FIG. 4 is a block diagram illustrating a structural architecture corresponding to the workflow illustrated in FIG. 3, according to certain aspects of the present disclosure.

FIG. 5 is a block diagram illustrating a system architecture comprising a DHE program and a validator program executing on a validator machine, according to certain aspects of the present disclosure.

FIG. 6 is a block diagram illustrating a cryptographic verification system implementing aspects of the subject technology, according to certain aspects of the present disclosure.

FIG. 7 illustrates a flowchart of an exemplary computer-implemented method for implementing secure transfers in a distributed ledger system, according to certain aspects of the present disclosure.

FIG. 8 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

### General Overview

Distributed computing systems and blockchain networks process and store data across multiple participants but face significant challenges in maintaining data confidentiality while enabling computation on encrypted data. Traditional encryption schemes protect data at rest and in transit but require decryption before computational operations can be performed, creating security vulnerabilities during processing. Fully Homomorphic Encryption (FHE) schemes allow computation directly on encrypted data without decryption, but implementing such schemes in distributed environments requires high network bandwidth and computational costs, which limits the protocol's ability to scale a validator set for a blockchain network. Conventional FHE approaches require computationally intensive bootstrapping operations to manage noise accumulation in ciphertexts, with single bootstrapping operations consuming significant processing time. In addition, many existing FHE constructions rely on binary or bit-level decomposition techniques, which render fundamental arithmetic operations on large encrypted integers highly inefficient. Non-arithmetic operations such as comparisons, divisions, and conditional evaluations on encrypted data typically require polynomial approximation techniques that are computationally expensive and impractical for real-time applications. These computational and bandwidth constraints significantly limit scalability in distributed validator environments, particularly where large validator sets and low-latency execution are required.

In blockchain networks, maintaining confidentiality of transaction data and smart contract states while enabling validators to verify and execute operations presents unique challenges. Public blockchain systems typically provide only pseudonymity through public key addresses, exposing transaction amounts, account balances, and contract interactions to all network participants. Although this mechanism obscures direct identity attribution, once an address is associated with a real-world entity, all historical and future transaction data, account balances, and contract interactions linked to that address become publicly accessible. Therefore, this lack of confidentiality presents exposure risk and has limited adoption for applications requiring sensitive data management and confidential business operations (for example, high-value financial use cases).

Some attempts to address these limitations include threshold fully homomorphic encryption (thFHE) schemes that enable confidential smart contract execution by distributing decryption authority among validators using threshold cryptosystems. However, such systems often require validators to share components of a common decryption key and depend on computationally intensive FHE primitives. The resulting high computational overhead, bandwidth requirements, and reliance in some cases on specialized hardware accelerators, trusted execution environments (TEEs), or application-specific integrated circuits (ASICs) constrain scalability and decentralization. Furthermore, limitations in supported integer sizes and arithmetic efficiency restrict their suitability for real-world financial applications, where large numerical ranges and precise arithmetic operations are essential. Consequently, existing approaches have struggled to meet market performance requirements without imposing substantial infrastructure burdens on network participants.

Embodiments, as disclosed herein, provide a solution to the above-mentioned limitations rooted in computer technology, namely, a distributed homomorphic encryption (DHE) protocol configured to enable confidential computation and transaction processing within distributed ledger systems. According to embodiments, the DHE protocol combines fully homomorphic encryption (FHE), multiparty computation (MPC), and zero-knowledge proof mechanisms in an optimized architecture that supports encrypted state execution without exposing plaintext values to validators or network participants. The DHE protocol is configured to support arithmetic and non-arithmetic operations on encrypted data, ensure deterministic state replication across validator nodes, and maintain cryptographic accountability and key management continuity in dynamic validator environments. The DHE protocol leverages the inherently distributed architecture of blockchain networks, in which a plurality of validators are continuously online and collectively maintain secret key shares, to accelerate computationally intensive cryptographic operations. Rather than performing expensive FHE procedures locally at a single node—such as bootstrapping for noise reduction or polynomial-approximation-based comparison operations—the DHE protocol distributes these operations across the validator set using interactive MPC subroutines.

According to embodiments, the DHE protocol employs a Generalized Brakerski-Fan-Vercauteren (GBFV) homomorphic encryption scheme configured to support efficient arithmetic operations, such as addition, subtraction, and multiplication, on large encrypted integer values as part of smart contract computations. In some embodiments, custom MPC protocols are integrated natively into the GBFV scheme to replace computationally intensive local homomorphic procedures with coordinated distributed operations.

In some embodiments, the DHE protocol replaces computationally intensive offline bootstrapping (noise reduction) procedures with an interactive bootstrapping subroutine implemented as a single-round MPC protocol executed during block construction. This interactive bootstrapping mechanism reduces latency and computational overhead while preserving ciphertext correctness and bounded noise growth. Non-arithmetic operations, such as division and comparisons, traditionally require time-consuming polynomial approximation techniques. According to some embodiments, the DHE protocol replaces polynomial approximation techniques for non-arithmetic operations with deterministic MPC protocols executed during block construction. These MPC-based protocols ensure consistent replication of the blockchain state across all validators, without requiring computationally expensive circuit-based approximation techniques.

Blockchains need a single network public encryption key under which all transactions, smart contract states, and encrypted values are encrypted to enable native smart contract interoperability. Accordingly, the corresponding private key must be distributed among validator nodes. According to embodiments, the DHE protocol uses an MPC-based distributed key generation (DKG) to securely generate and split decryption key shares between validators, such that no single validator possesses the complete private key. Because the validators already possess secret key shares generated during DKG, the validators can collaboratively execute bootstrapping, comparison, and related non-arithmetic functions more efficiently through coordinated communication rounds. This approach replaces slow, standalone FHE computations with communication-efficient distributed protocols that are well-suited to blockchain environments, thereby reducing latency, improving scalability of the validator set, and maintaining threshold security without requiring any single validator to reconstruct the complete private key. In some embodiments, threshold cryptography mechanisms are used to enable any subset of at least a threshold number of validators to cooperatively perform decryption operations, thereby mitigating centralization risks.

According to embodiments, zero-knowledge proofs are employed to ensure correctness of encryption and transaction formation. In some embodiments, users generate proof circuits demonstrating correct encryption of plaintext values under the network public key. Users publish the resulting proofs to the network along with their transactions. Validators verify such proofs prior to executing homomorphic operations on the submitted ciphertexts, preventing malicious activity of users (for example, tampering their or others' balances). The zero-knowledge proof circuits may be implemented using proving systems (for example, Halo2, Gnark, etc.), thereby enabling efficient verification within blockchain environments.

According to embodiments, client-side cryptographic operations, including encryption, decryption requests, and zero-knowledge proof generation, are triggered through a decentralized application frontend using a software development kit or integrated directly into a non-custodial wallet environment. According to some embodiments, FHE and select MPC operations are integrated into a blockchain-native precompile including, but not limited to, operations for setting the network public key following DKG, performing encrypted comparisons, encrypted division, and decryption.

The disclosed subject technology further provides improvements within systems requiring data confidentiality, such as distributed ledger systems. In particular, the DHE protocol enables efficient key resharing to support dynamically changing validator sets without altering the network public key or re-encrypting existing ciphertexts. Secure handling of decryption operations is achieved under an honest-majority assumption using threshold cryptography with enforced validator accountability. The system provides native support for large-value encryption and arithmetic within smart contracts using the GBFV scheme. Additionally, comparisons, equality checks, and bootstrapping are performed using custom MPC subroutines in place of computationally intensive local homomorphic evaluations. Confidential smart contract execution is thereby enabled, with inputs and outputs obfuscated, and MPC operations executed during block construction (prior to block finalization) to ensure atomic (wherein sender and receiver balances are modified concurrently as a single, indivisible state transition) and deterministically replicated state transitions across validators. Collectively, these features provide technical improvements in scalability, computational efficiency, validator decentralization, and encrypted smart contract interoperability within distributed ledger systems, thereby enabling practical and verifiable confidential computation at blockchain scale.

According to some embodiments, the DHE protocol described herein may be applied to any use case requiring data confidentiality while enabling computation directly on encrypted data, particularly in systems employing distributed computation. The term “distributed computation,” as used herein, refers to a computational model in which processing tasks are divided among multiple computing nodes that cooperate to perform operations collectively, thereby eliminating reliance on a single trusted computing entity. Examples of such use cases include, without limitation, private machine learning model training, sealed-bid auction systems, private know-your-customer and anti-money-laundering verification processes, and secure data analysis operations performed on encrypted sensitive datasets such as healthcare records, financial data, or criminal records. According to some embodiments, the DHE protocol enables these applications by providing homomorphic operations on encrypted data combined with MPC protocols for operations that would otherwise require decryption, thereby maintaining data confidentiality throughout the computational workflow.

### Example System Architecture

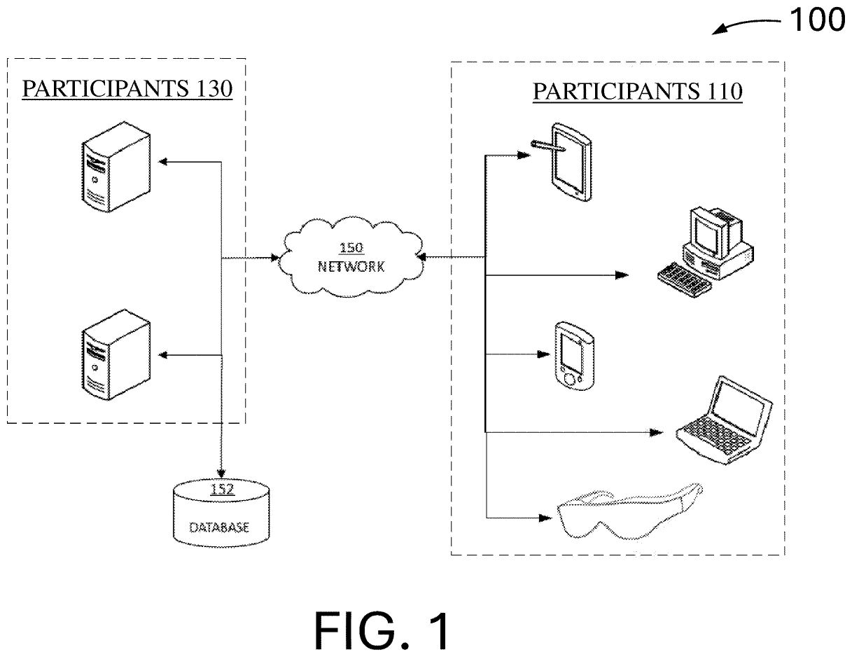

FIG. 1 illustrates a network architecture 100 used to implement a distributed homomorphic encryption protocol for confidential computation in a blockchain network, according to some embodiments.

In the example of FIG. 1, the network architecture 100 includes one or more participants 110 and one or more participants 130 which are communicatively coupled through a network 150. The network 150 may include a wired network (for example, via fiber optic or copper wire, telephone lines, and the like) and/or a wireless network (for example, a satellite network, a cellular network, radiofrequency (RF) network, Wi-Fi, Bluetooth, and the like).

The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

The participants 110 may include any one of a laptop computer, a desktop computer, or a mobile device such as a smart phone, a palm device, a tablet device, a television, a wearable device, a display device, or other device with sufficient computational, storage, and communication resources to execute software implementing various aspects of embodiments and that can be stored in a memory of the device. In some embodiments, the participants 110 may function as client devices for submitting encrypted transactions to one or more blockchain networks that implement the distributed homomorphic encryption protocol. In some embodiments, the participants 110 may comprise a plurality of nodes for a blockchain network, wherein a node may comprise an application or other software that records and monitors peer connections to other nodes and validators for the blockchain network.

Participants 130 may be a cloud server or a group of cloud servers. In other embodiments, some or all of the participants 130 may not be cloud-based servers (i.e., may be implemented outside of a cloud computing environment, including but not limited to an on-premises environment), or may be partially cloud-based. Some or all of the participants 130 may be a computing device such as part of a cloud computing server including one or more desktop computers or panels mounted on racks, and/or the like. The panels may include processing boards and also switchboards, routers, and other network devices. In some embodiments, the participants 130 may include the participants 110 as well, such that they are peers.

The participants 110 and/or the participants 130 may function as validator nodes for one or more blockchains implemented on the network architecture 100. As an example, the participants 110 and/or the participants 130 may execute virtual machines (VMs) that validate blocks and transactions, store distributed ledger data, execute confidential smart contracts on encrypted state data, and verify zero-knowledge proofs associated with encrypted transactions. As a non-limiting example, multiple participants 110 may have access to at least one blockchain network hosted by the participants 130. As another non-limiting example, the participants 130 may provide services such as Internet based services including web2 services and web3 services, for example, to the participants 110.

The participants 130 may store blockchain data in a peer-to-peer (P2P) and/or distributed ledger fashion in a database 152. The database 152 may be a single database or a distributed database. The database 152 may store relevant information including, but not limited to, encrypted ciphertext data, network public encryption keys, re-linearization keys, execution and verification logic for homomorphic operations, and rules for implementing consensus and messaging protocols. The participants 130 may be configured to concurrently implement multiple blockchains of different types, including but not limited to a platform chain for coordinating validators and tracking active subnets, and a subnet blockchain for confidential transaction processing using a distributed homomorphic encryption protocol.

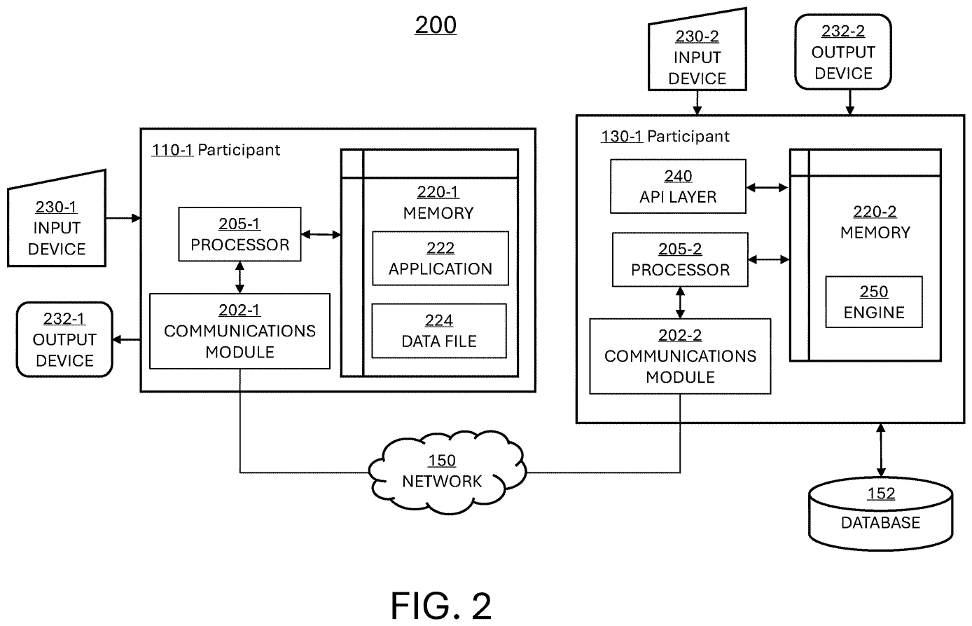

FIG. 2 is a block diagram illustrating details of participants implementing Distributed Homomorphic Encryption (DHE) in the architecture of FIG. 1, according to some embodiments. Specifically, the example of FIG. 2 illustrates an exemplary participant 110-1 (of the participants 110) and an exemplary participant 130-1 (of the participants 130) of the network architecture 100 of FIG. 1. System 200 is configured to implement blockchain consensus, confidential transaction processing, threshold cryptographic operations, and multiparty computation (MPC) subroutines in accordance with the DHE protocol on the network architecture 100.

The participant 110-1 may be a client device and the participant 130-1 may be a validator node. The participant 110-1 and the participant 130-1 may access each other and other participants (for example, validator nodes) in the network 150 via corresponding communications modules 202-1 and 202-2, respectively. For example, participant 110-1 and the participant 130-1 may be connected by wired or wireless means to the Internet and support communication with a blockchain distributed ledger supporting confidential smart contracts via communications modules 202-1 and 202-2. While certain embodiments are described in the context of a blockchain network, alternative distributed ledger or distributed computing environments may also be used.

The communications modules 202-1 and 202-2 may be, for example, modems or Ethernet cards, and may include radio hardware and software for wireless communications (for example, via electromagnetic radiation, such as radiofrequency (RF), near field communications (NFC), Wi-Fi, and Bluetooth radio technology). The participant 110-1 and participant 130-1 also include a processor 205-1, 205-2 and memory 220-1, 220-2, respectively. Communications modules 202-1 and 202-2, processors 205-1 and 205-2, and memories 220-1 and 220-2 will be collectively referred to, hereinafter, as “communications modules 202,” “processors 205,” and “memories 220.” Processors 205 may be configured to execute instructions stored in memories 220, to cause participant 110-1 and/or participant 130-1 to perform methods and operations consistent with embodiments of the present disclosure including, but not limited to, blockchain setup/initialization, encryption, proof generation, MPC coordination, homomorphic evaluation, threshold decryption, and blockchain state updates.

The participant 110-1 and the participant 130-1 are coupled to at least one input device 230-1 and input device 230-2, respectively (hereinafter, collectively referred to as “input devices 230”). The input devices 230 can include a mouse, a keyboard, a pointer, a stylus, a touchscreen, a microphone, voice recognition software, a joystick, a virtual joystick, a touch-screen display, and the like. The participant 110-1 and the participant 130-1 are also coupled to at least one output device 232-1 and output device 232-2, respectively (hereinafter, collectively referred to as “output devices 232”). The output devices 232 may include a display (for example, a same touchscreen display used as an input device), a speaker, an alarm, and the like. A user may interact (for example, initiate confidential transactions, generate encrypted inputs, and submit zero-knowledge proofs) with participant 110-1 and/or participant 130-1 via the input devices 230 and the output devices 232.

The participant 110-1 can implement and/or manage the blockchain framework described herein by application 222 executing within memory 220-1 and couple with input devices 230 and output devices 232. For example, application 222 may include or interface with a software development kit (SDK) configured to perform encryption of transaction values and proof generation, according to aspects of embodiments. The application 222 may be downloaded by a user from participant 130-1, and/or may be hosted by participant 130-1. The application 222 includes specific instructions which, when executed by processor 205-1, perform operations consistent with embodiments of the present disclosure.

In some embodiments, application 222 runs on an operating system (OS) installed on participant 110-1. In some embodiments, application 222 may run within a web browser, decentralized application (dApp), wallet, finance application, or the like. In some embodiments, the processor 205-1 is configured to control a graphical user interface (GUI) (spanning at least a portion of input devices 230 and output devices 232) for the user of participant 110-1 to access participant 130-1.

Data and files associated with the application 222 may be stored in a local data file 224 stored in memory 220-1, a local database of participant 110-1 or participant 130-1, or an external database (for example, database 152, a distributed database, and the like). The participant 110-1 may be used to perform blockchain-related operations including, without limitation, transaction submission, encrypted value transfers, validation requests, and smart contract interactions.

Participant 130-1 includes an application programming interface (API) layer 240, configured to provide data, instructions, or updates to application 222 in participant 110-1. API layer 240 may facilitate communication between client devices and blockchain services implementing the DHE protocol. Participant 130-1 may execute validator logic and protocols stored in memory 220-2. In some embodiments, memory 220-2 of participant 130-1 includes a blockchain engine 250 configured to perform operations consistent with embodiments of the present disclosure. The blockchain engine 250 is configured to manage block production, consensus participation, transaction validation, and state transitions. For example, during block building, encrypted transaction data may be processed via a DHE module of the blockchain engine 250, which performs required MPC subroutines prior to block finalization to ensure atomic and deterministic state updates across all validators. A user may access the blockchain engine 250 through application 222 executing on participant 110-1.

### Distributed Homomorphic Encryption Framework

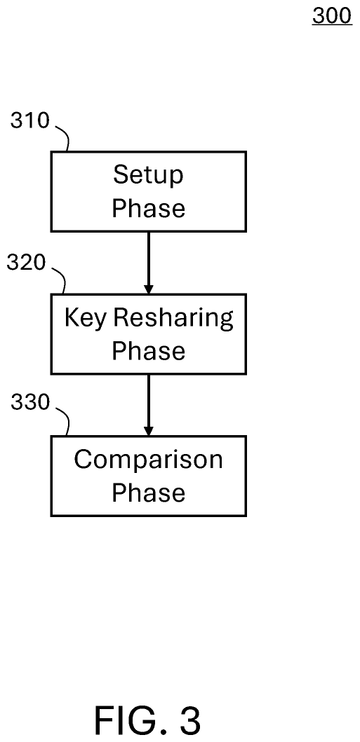

FIG. 3 is a workflow diagram illustrating phases 300 of a DHE protocol including a setup phase 310, a key resharing phase 320, and a comparison phase 330, according to some embodiments. According to some embodiments, the DHE protocol 300 comprises three distinct operational phases that are performed at different stages of the blockchain lifecycle to establish, maintain, and utilize cryptographic key material for confidential computation on encrypted data.

According to some embodiments, the setup phase 310 is performed once during blockchain initialization to establish all necessary cryptographic components before the system becomes operational, ensuring that cryptographic infrastructure is properly initialized prior to processing confidential transactions. All validator nodes in the network participate in the setup phase 310. The setup phase 310 includes distributed key generation (DKG) operations to generate cryptographic components (for example, a network public encryption key, re-linearization key, secrets keys). Each validator node independently generates a respective secret key and derives various secret key shares from the secret key to contribute to system-wide cryptographic setup operations.

According to some embodiments, the DKG operations include distributed public key generation protocols that derive a public encryption key from aggregated contributions of secret key shares from all participating validator nodes in the network. The public encryption key may be used for encrypting transaction data and enabling homomorphic operations on ciphertexts encrypted under the common network public encryption key. According to some embodiments, generating the public encryption key requires a single round of communication among validator nodes to collectively generate the network public encryption key without any single validator possessing the complete private key that corresponds to the distributed, network public key encryption key generated via DKG.

According to some embodiments, the setup phase 310 includes re-linearization key generation operations that generate a re-linearization key based on secret shares of participating validator nodes. The re-linearization key is used to reduce the degree of resulting ciphertexts from homomorphic multiplication operations performed on encrypted data to maintain computational efficiency. According to some embodiments, generating the re-linearization key requires two rounds of communication among validator nodes to securely generate and distribute the re-linearization key to the network. In some implementations, a single-round scheme may be employed.

According to some embodiments, the setup phase 310 includes threshold key generation operations wherein a group of validator nodes creates a collective secret key structure without requiring a trusted dealer. This ensures that no single participant ever holds the entire private key. This mechanism enforces a threshold-based security model where operations require a minimum number of participants to collaborate on decryption and bootstrapping operations. In the threshold key generation operations, the validator nodes participate in one-round, pairwise communication to re-share key components (secret key shares) among participating nodes using cryptographic secret-sharing techniques. In some embodiments, threshold key generation operations use a variant of Shamir secret-sharing defined over the Ring Learning With Errors (RLWE) ring to re-share the key components. In some embodiments, the threshold key generation operations convert an N-out-of-N secret key structure into a t-out-of-N threshold structure, enabling any subgroup of at least t validator nodes to combine their respective threshold secret key shares to perform decryption operations or other secret-key-dependent operations efficiently without requiring participation of all N validator nodes.

According to some embodiments, the key resharing phase 320 supports dynamic changes in the validator set. The key resharing phase 320 is triggered when the validator set changes due, for example, to validators joining or leaving the network. A change in the validator set necessitates redistribution of threshold secret key shares to accommodate the updated validator set while maintaining continuity of the blockchain's cryptographic infrastructure. According to embodiments, the key resharing phase 320 performs distributed re-sharing of secret key shares across participating validator nodes to derive fresh threshold secret key shares of the complete private key for an updated validator set without changing the network public encryption key. The key resharing phase 320 maintains the same network public encryption key established during the setup phase 310, ensuring that previously encrypted on-chain values remain valid and operational without requiring decryption and re-encryption under a new public key. The key resharing phase 320 enables newly joined validators to obtain their respective threshold secret key shares and revokes key shares from departed validators, thereby maintaining the threshold decryption capability with the current active validator set.

According to some embodiments, the key resharing phase 320 utilizes similar cryptographic techniques as the threshold key generation operations of the setup phase 310, including pairwise communication among validator nodes and Shamir secret-sharing operations over the RLWE ring to redistribute threshold key shares while preserving the underlying secret key structure. This ensures that the threshold security property may be maintained with the updated validator set, such that any subset of at least t validators from the new validator set may combine their fresh threshold secret key shares to perform decryption operations on ciphertexts that were encrypted under the unchanged network public encryption key.

According to some embodiments, the comparison phase 330 is performed during confidential smart contract execution to enable secure comparison operations (for example, greater-than comparisons, less-than comparisons) on encrypted values. According to some embodiments, the comparison phase 330 implements MPC protocols executed among validator nodes to perform non-arithmetic operations in a deterministic manner on encrypted ciphertexts. The MPC protocols are executed during block building operations prior to block finalization. This ensures that all validator nodes perform the same secure comparison operations on encrypted data and arrive at consistent results for correct replication of blockchain state across the distributed network, maintaining consensus and correctness of confidential smart contract execution. According to some embodiments, the comparison phase 330 may be invoked multiple times during execution of a single confidential smart contract transaction when the smart contract logic requires multiple comparison operations or conditional evaluations on different encrypted values stored in the blockchain state.

According to embodiments, the DHE protocol requires that every message exchanged between validator nodes is signed using the sending validator node's secret key to ensure accountability. Every signature and corresponding message is stored by every validator node to enable subsequent auditing and tracing of cryptographic operations back to specific participants. In some embodiments, the storage of signed messages enables detection of incorrect or corrupted values by allowing validators to retrospectively audit stored messages and identify which validator node produced invalid cryptographic contributions through signature verification. Accordingly, messages exchanged during all protocol phases—including, but not limited to, block building, transaction execution, distributed key generation, key resharing, and multiparty computation—are signed and stored. This approach ensures complete auditability and traceability using the DHE protocol.

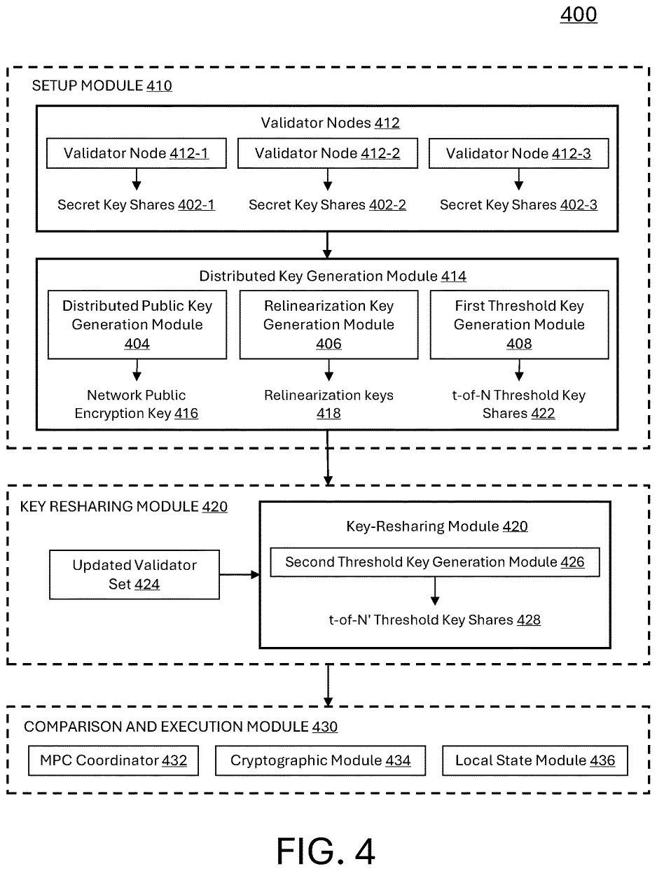

FIG. 4 is a block diagram illustrating a structural architecture 400 corresponding to the workflow illustrated in FIG. 3, according to some embodiments.

According to some embodiments, the structural architecture 400 includes a setup module 410 corresponding to the setup phase 310 of FIG. 3, a key resharing module 420 corresponding to the key resharing phase 320 of FIG. 3, and a comparison and execution module 430 corresponding to the comparison phase 330 of FIG. 3. The components illustrated in FIG. 4 may be implemented within each validator node of a blockchain network or within a validator set of the blockchain network. In the example shown in FIG. 4, three validator nodes are depicted for purposes of illustration only. The number of validator nodes is not limited to the illustrated example and may include any suitable number of nodes, including fewer or greater than three.

A plurality of validator nodes 412 including validator node 412-1, validator node 412-2, and validator node 412-3 independently generate secret key shares 402-1, secret key shares 402-2, and secret key shares 402-3 (collectively referred to as “secret key shares 402”), respectively. The secret key shares 402 are derived from each validator nodes' 412 secret key.

According to embodiments, the setup module 410 structurally implements the setup phase 310 described in FIG. 3 including a distributed key generation module 414. According to embodiments, the distributed key generation module 414 includes a distributed public key generation module 404, a re-linearization key generation module 406, and a first threshold key generation module 408.

According to embodiments, the distributed public key generation module 404 is configured to aggregate the contributions of secret key shares 402 from all participating validator nodes 412 to generate a network public encryption key 416. The network public encryption key 416 enables encryption of transaction data and homomorphic operations across ciphertexts encrypted under a common public key, without any single validator possessing the complete corresponding private key.

According to embodiments, the re-linearization key generation module 406 is configured to generate one or more re-linearization keys 418 based on the secret key shares 402 contributed by the validator nodes 412. Generation of the re-linearization keys 418 involves one or more rounds of communication among the validator nodes 412. In some instances of FHE, when two ciphertexts are multiplied homomorphically, the resulting ciphertext contains additional components that increase the dimensionality or degree of the ciphertext representation. This growth introduces redundant or unwanted components that increase the computational complexity of subsequent operations. To address this, re-linearization key generation module 406 is configured to apply re-linearization to the resulting ciphertext to reduce the degree of ciphertexts resulting from homomorphic multiplication operations. By reducing ciphertext expansion following multiplication, the re-linearization key generation module 406 maintains computational efficiency during confidential smart contract execution.

According to embodiments, the first threshold key generation module 408 is configured to identify a threshold secret sharing structure including t-of-N (where N=3 in the example of FIG. 4) validator nodes of the validator nodes 412. The first threshold key generation module 408 is configured to generate, using cryptographic secret-sharing techniques, threshold key shares 422 for each party in the group of t-of-N validator nodes based on the secret keys of the parties. The first threshold key generation module 408 is further configured to re-share the threshold key shares 422 with the N validator nodes (that is, all consensus participants). This enables any subset of at least t validator nodes 412 to cooperatively perform decryption operations or other secret-key-dependent cryptographic operations without requiring participation of all N validator nodes in the blockchain network.

According to embodiments, the key resharing module 420 structurally implements the key resharing phase 320 described in FIG. 3. The key resharing module 420 includes an updated validator set 424 and a second threshold key generation module 426. According to embodiments, the updated validator set 424 is configured to identify validator join events and validator leave events within the blockchain network. When the validator set (for example, validator node 412) changes, the key resharing module 420 performs distributed re-sharing of threshold secret key shares among the updated validator set. According to embodiments, the second threshold key generation module 426 is configured to identify a group (or subset) t-of-N′ validator nodes, where N′ is the updated validator set. The network public encryption key 416 is preserved. The second threshold key generation module 426 is configured to generate fresh threshold key shares 428 for each party in the group of t-of-N′ validator nodes based on the secret keys of the parties. The second threshold key generation module 426 is configured to re-share the threshold key shares 428 with the N validator nodes.

In some embodiments, the key resharing module 420 utilizes the same or similar cryptographic techniques as the first threshold key generation module 408 to re-distribute and refresh threshold secret key shares among the updated validator set without reconstructing the underlying private key and without modifying the network public encryption key 416.

According to embodiments, the comparison and execution module 430 structurally implements the comparison phase 330 described in FIG. 3. The comparison and execution module 430 includes a multiparty computation (MPC) coordinator 432, a cryptographic module 434, and a local state module 436.

According to embodiments, the MPC coordinator 432 is configured to orchestrate interactive MPC protocols and sub-protocols executed among validator nodes 412 during block building prior to block finalization.

According to embodiments, the cryptographic module 434 is configured to perform homomorphic and MPC-integrated cryptographic operations. In some embodiments, cryptographic module 434 is configured to perform homomorphic cryptographic operations using a GBFV encryption scheme. The cryptographic module 434 performs homomorphic addition, subtraction, scalar multiplication, ciphertext multiplication, re-linearization using re-linearization keys 418, threshold decryption using threshold key shares 422 (or threshold key shares 428), and MPC-integrated bootstrapping operations for ciphertext noise reduction.

According to embodiments, encrypted comparison operations—including greater-than comparisons, less-than comparisons, and equality determinations—are executed through MPC protocols coordinated by the MPC coordinator 432 and executed by the cryptographic module 434. These MPC protocols are performed in a deterministic manner during block building to ensure that all validator nodes 412 (and, similarly, updated validator set, when applicable) derive identical results for correct replication of blockchain state across the distributed network.

According to embodiments, the local state module 436 is configured to store peer information including but not limited to, identifying validator nodes 412, protocol state variables, signed MPC messages, the network public encryption key 416, re-linearization keys 418, and other cryptographic materials required for execution. The local state module 436 enables consistent state maintenance across validator nodes and supports finalization of blocks containing confidential transactions.

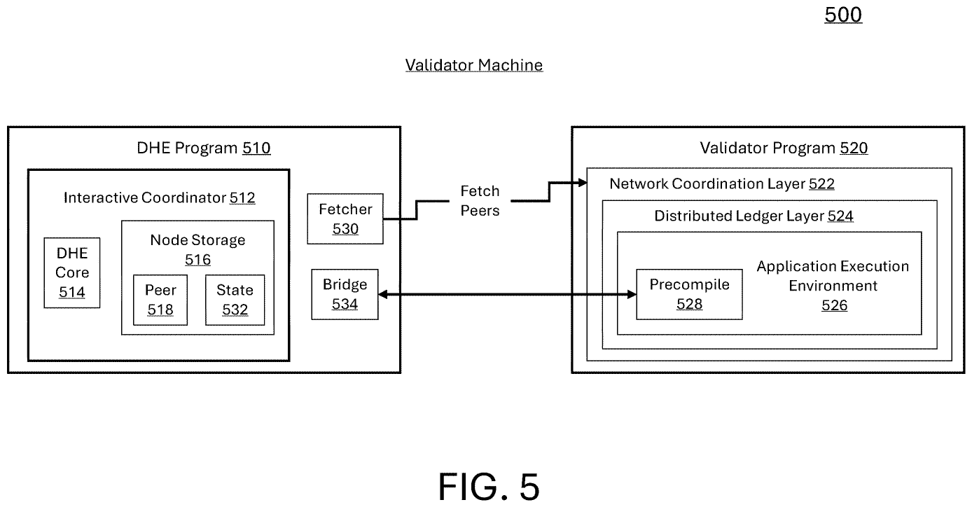

FIG. 5 is a block diagram illustrating a system architecture 500 comprising a distributed homomorphic encryption (DHE) program 510 and a blockchain validator program 520 both executing on a validator machine. According to embodiments, the DHE program 510 and the validator program 520 communicate via a local bridge 534.

As used herein, a validator machine refers to a computing system executing a validator program and associated auxiliary programs, including distributed cryptographic programs, to enable participation in a distributed ledger network. As used herein, a validator program refers to a collection of software components executed by the validator machine to support participation in a distributed ledger network, including coordination, ledger maintenance, and execution functionality. Each validator machine executes validator software and maintains state storage used to support consensus participation, transaction validation, and protocol execution.

According to embodiments, the validator program 520 includes a network coordination layer 522, a distributed ledger layer 524, and an application execution environment 526. In some embodiments, the network coordination layer 522 may comprise a platform registry chain, such as a platform chain (P-chain), configured to maintain registry information associated with validator nodes and to facilitate coordination among the validator nodes within the network. In some embodiments, the distributed ledger layer 524 may comprise a blockchain network configured to support confidential smart contract execution across a plurality of validator nodes and processing of encrypted transaction data smart contracts. In some embodiments, the application execution environment 526 may comprise a virtual machine operating within a subnet of the blockchain network, the virtual machine being configured to process transactions, execute smart contracts, and interface with cryptographic operations associated with the distributed ledger layer.

According to embodiments, the application execution environment 526 includes a precompile 528 configured to execute protocol-integrated logic as part of blockchain transaction execution. In some embodiments, the validator program 520 performs standard blockchain functions including transaction processing, state maintenance, and consensus participation, while delegating certain cryptographic operations to the DHE program 510.

According to embodiments, the DHE program 510 comprises multiple components including a fetcher 530, the bridge 534, an interactive coordinator 512, a DHE core 514, and a node storage 516. The DHE program 510 executes on every validator machine participating in the DHE protocol and performs distributed homomorphic encryption and multiparty computation (MPC) operations. The DHE program 510 operates as a separate program from the validator program 520, with both programs executing on the same validator machine. In some embodiments, MPC communications occur directly between DHE programs executing on different validator machines rather than being routed through blockchain validator programs, thereby enabling peer-to-peer cryptographic protocol execution independent of blockchain consensus mechanisms.

According to embodiments, bridge 534 establishes and maintains a local communication channel between the validator program 520 and the DHE program 510. In some embodiments, bridge 534 is implemented as a local communication interface including, but not limited to, a local HTTP connection, enabling communication between the two programs without requiring external network transmission. By non-limiting example, during execution of encrypted transactions, the precompile 528 retrieves encrypted ciphertext data from blockchain state maintained by the distributed ledger layer 524 and transmits the ciphertext to the DHE program 510 via the local bridge 534. Receipt of ciphertext data by the DHE program 510 from the precompile 528 indicates that the DHE program 510 is to perform the required DHE logic, according to one or more embodiments. Upon completion of the cryptographic processing, the DHE program 510 returns computation results to the precompile 528 via the local bridge 534. The precompile 528 then writes the results back to the blockchain state and continues transaction execution to finalize the transaction based on the DHE program 510 results.

According to embodiments, fetcher 530 is configured to obtain validator discovery information from the network coordination layer 522. The network coordination layer 522 may serve as a registry in which validators register public keys and network addresses. The fetcher 530 is configured to retrieve validator peer information from the network coordination layer 522 so that the DHE program 510 can perform MPC operations using validator-specific information.

According to embodiments, interactive coordinator 512 is configured to coordinate execution of the DHE protocol including MPC sub-protocols among participating validators. The MPC sub-protocols may be executed among validator nodes to perform cryptographic operations on encrypted data, including comparison operations and interactive bootstrapping procedures. In some embodiments, the interactive coordinator 512 is further configured to perform leader selection from a validator set, determine where protocol messages should be sent, and orchestrate distributed cryptographic protocol execution. In some embodiments, interactive coordinator 512 manages protocol flow and message routing during MPC operations.

According to embodiments, DHE core 514 implements cryptographic operations for the DHE scheme including, for example, distributed key generation, re-linearization, threshold key generation, resharing operations, homomorphic encryption, comparison, and other cryptographic components required to support the DHE scheme.

According to embodiments, node storage 516 includes state storage 532 and peer storage 518. In some embodiments, state storage 532 comprises one or more storage resources configured to store protocol state information and cryptographic material used by the DHE program 510. Such stored data may include, by way of non-limiting example, the network public encryption key, threshold key shares, re-linearization keys, digital signatures, signed protocol messages, and other cryptographic state data. In some embodiments, peer storage 518 stores MPC peer information identifying validator nodes participating in the DHE protocol. At least a portion of the MPC peer information may correspond to data fetched by fetcher 530 from the network coordination layer 522.

According to some embodiments, protocol messages exchanged between validators during MPC are digitally signed using the sending validator's secret key and stored within the DHE program 510. The stored signed messages enable subsequent audit operations to identify validators responsible for incorrect or corrupted values by tracing protocol messages to originating validators through cryptographic signature verification. Such protocol messages and associated storage are maintained within the DHE program 510 and are not exposed to the validator program 520, thereby maintaining separation between MPC operations and blockchain consensus operations.

In some embodiments, the validator program 520 and the DHE program 510 are operational prior to initiation of a setup phase. The setup phase may be triggered externally, for example when one or more validators indicate that distributed key generation should commence. If validators collectively agree to participate in the setup phase, the setup phase begins, enabling the distributed homomorphic encryption protocol to operate in conjunction with on-chain transaction execution.

In the illustrated system architecture 500, confidential smart contract execution is enabled by maintaining encrypted state data on-chain while performing homomorphic computation and multiparty computation operations within the DHE program 510. This architecture provides confidentiality for transaction inputs, smart contract state, and computation results while preserving verifiability through the blockchain consensus mechanism.

### Distributed Homomorphic Encryption System

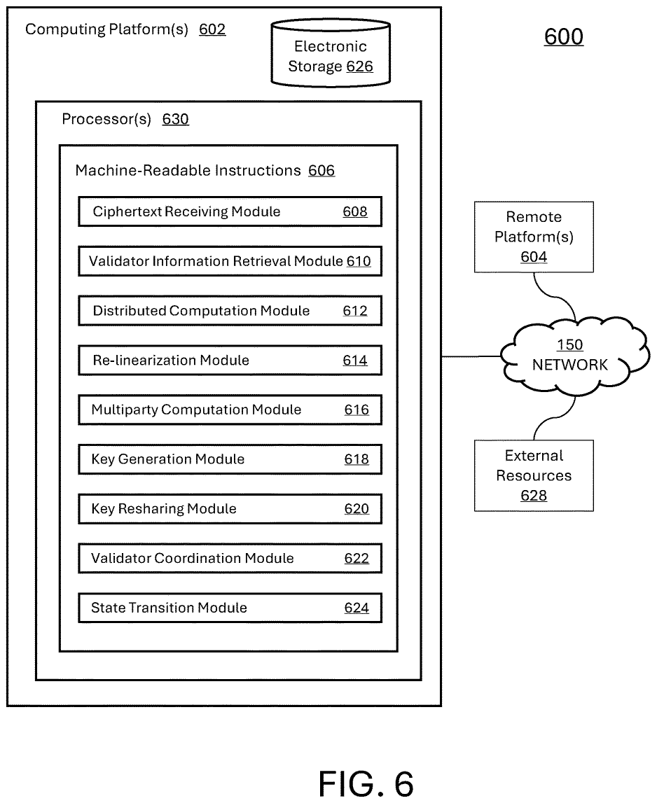

FIG. 6 is a block diagram illustrating a distributed homomorphic encryption (DHE) system 600 implementing aspects of the subject technology, according to one or more embodiments. DHE system 600 may be implemented within a blockchain network and is configured to enable confidential transaction processing by performing distributed homomorphic encryption and multiparty computation (MPC) operations over encrypted values. According to some embodiments, the DHE system 600 operates in conjunction with a blockchain validator program and may be implemented, in whole or in part, as a protocol-integrated execution component, a precompile-invoked auxiliary program, or a validator-resident cryptographic service that supports encrypted state transitions.

In some implementations, system 600 may include one or more computing platforms 602 executing various aspects of the system. The computing platform(s) 602 may correspond to validator machines, blockchain nodes, execution engines, or native verification environments responsible for transaction validation, cryptographic protocol execution, and state updates, which can be similar to or the same as the computing device(s) of participants 130 of FIG. 1 and include the client computing device(s) of participants 110 of FIG. 1 and include the processors 205 in FIG. 2.

Computing platform(s) 602 may be configured to communicate with one or more remote platforms 604 according to a client/server architecture, a peer-to-peer architecture, and/or other distributed communication architectures. The remote platform(s) 604 may be configured to communicate with other remote platforms via computing platform(s) 602 and/or according to a client/server architecture, a peer-to-peer architecture, and/or other architectures. The remote platform(s) 604 can be configured to cause output of the system 600 on client device(s) of the remote platform(s) 604 with enabled access according to stored data. In some embodiments, the remote platform(s) 604 correspond to other validator machines executing instances of the DHE program. Communication among the computing platform(s) 602 and remote platform(s) 604 enables execution of multiparty computation protocols among validators participating in the DHE protocol. The computing platform(s) 602, external resources 628, and remote platform(s) 604 may be in communication and/or mutually accessible via the network 150.

The computing platform(s) 602 may be configured by machine-readable instructions 606. The machine-readable instructions 606 may be executed by the computing platform(s) to implement one or more instruction modules. The instruction modules may include computer program modules. The instruction modules being implemented may include one or more of a ciphertext receiving module 608, a validator information retrieval module 610, a distributed computation module 612, a re-linearization module 614, a multiparty computation module 616, a key generation module 618, a key resharing module 620, a validator coordination module 622, and a state transition module 624. Execution of the machine-readable instructions 606 causes the computing platform(s) 602 to perform the DHE protocol in coordination with blockchain transaction execution, thereby enabling confidential computation over encrypted data while preserving blockchain verifiability.

The ciphertext receiving module 608 may be configured to receive, at a node of a plurality of nodes in a distributed ledger network, one or more ciphertexts representing transaction data encrypted under a network encryption public key. According to some embodiments, the ciphertext receiving module 608 may further parse transaction payloads, identify encrypted inputs, and interface with a transaction queue of the distributed ledger network.

According to some embodiments, system 600 may be further configured to verify cryptographic proofs associated with received ciphertexts. According to embodiments, the ciphertext receiving module 608 may verify zero-knowledge proofs attesting to correct encryption under the network encryption public key without revealing plaintext values.

The validator information retrieval module 610 may be configured to obtain validator information from a shared registry maintained on the distributed ledger network. According to embodiments, the validator information may include validator identities, public keys, stake weights, participation thresholds, and committee assignments. In some embodiments, the validator information retrieval module 610 may dynamically update validator information in response to changes in the validator set.

The distributed computation module 612 may be configured to orchestrate execution of cryptographic operations across the plurality of nodes using the validator information. According to embodiments, the distributed computation module 612 may coordinate sequencing of protocol steps, enforce participation thresholds, and manage communication flows among validator nodes for DHE operations.

According to some embodiments, the distributed computation module 612 may be further configured to perform FHE operations on ciphertexts. According to embodiments, such operations may include homomorphic addition, subtraction, multiplication, and bootstrapping over ciphertexts encrypted under the network encryption public key. In some embodiments, the distributed computation module 612 may operate over ciphertexts encoded using GBFV schemes, an RLWE-based public-key encryption protocol suitable for large integer arithmetic.

The re-linearization module 614 may be configured to manage ciphertext growth resulting from homomorphic multiplication operations. According to embodiments, the re-linearization module 614 may generate or obtain re-linearization keys derived from secret key shares of the plurality of nodes and apply the re-linearization keys to reduce the degree and size of ciphertexts following multiplication operations.

The multiparty computation module 616 may be configured to execute interactive multiparty computation sub-protocols among the plurality of nodes. According to embodiments, the multiparty computation module 616 may enable non-arithmetic operations on encrypted data, including comparison operations, equality checks, division, conditional branching, and interactive bootstrapping. In some embodiments, the MPC sub-protocols may be integrated with FHE operations.

The key generation module 618 may be configured to generate and manage cryptographic keys used in the DHE protocol. According to embodiments, each node may generate secret key shares, and the key generation module 618 may aggregate the shares to derive a network encryption public key. The key generation module 618 may further distribute the network encryption public key to the plurality of nodes.

The key resharing module 620 may be configured to support dynamic validator sets. According to embodiments, the key resharing module 620 may be configured to detect changes in a validator set such as addition or removal of validator nodes. In response to a detected change, the key resharing module 620 may be configured to convert secret keys of a subset of nodes into threshold secret key shares using pairwise communication and secret sharing techniques, including, for example, Shamir secret sharing over an RLWE ring. The module may further redistribute updated threshold secret key shares in response to validator set changes, while maintaining the same network encryption public key.

The validator coordination module 622 may be configured to manage communication and coordination among validator nodes. According to embodiments, the validator coordination module 622 may handle message broadcasting, peer-to-peer communication, synchronization of protocol rounds, and enforcement of participation requirements for threshold operations.

According to some embodiments, system 600 may be further configured to provide accountability and traceability of cryptographic operations. According to embodiments, validator nodes may sign protocol messages using respective secret keys. The signed messages and corresponding signatures may be stored, enabling execution of cryptographic audits to detect misbehavior, verify protocol compliance, and support dispute resolution.

The state transition module 624 may be configured to execute state transitions within the distributed ledger network based on result ciphertexts produced by the distributed computation module 612. According to embodiments, the state transition module 624 may be configured to update encrypted account balances, enforce transaction validity conditions, and finalize transactions as atomic state updates. In some embodiments, the state transition module 624 may interface with a virtual machine or execution environment of the distributed ledger network to apply encrypted state changes without decrypting underlying data.

According to some embodiments, the modules described above collectively implement a DHE protocol that combines FHE operations with MPC sub-protocols to enable confidential, verifiable, and efficient computation over encrypted data in a decentralized environment.

In some implementations, the computing platform(s) 602, the remote platform(s) 604, and/or the external resources 628 may be operatively linked via one or more electronic communication links. For example, such electronic communication links may be established, at least in part, via the network 150 such as the Internet and/or other networks. It will be appreciated that this is not intended to be limiting, and that the scope of this disclosure includes implementations in which the computing platform(s) 602, the remote platform(s) 604, and/or the external resources 628 may be operatively linked via some other communication media.

A given remote platform 604 may include client computing devices, which may each include one or more processors configured to execute computer program modules. The computer program modules may be configured to enable an expert or user associated with the given remote platform 604 to interface with the system 600 and/or external resources 628, and/or provide other functionality attributed herein to remote platform(s) 604. By way of non-limiting example, a given remote platform 604 and/or a given computing platform 602 may include one or more of a server, a desktop computer, a laptop computer, a handheld computer, a tablet computing platform, a NetBook, a Smartphone, a gaming console, and/or other computing platforms. The external resources 628 may include sources of information outside of the system 600, external entities participating with the system 600, and/or other resources. For example, the external resources 628 may include externally designed blockchain elements and/or applications designed by third parties. In some implementations, some or all of the functionality attributed herein to the external resources 628 may be provided by resources included in system 600.

Computing platform(s) 602 may include the electronic storage 626, a processor such as the processors 630, and/or other components. The computing platform(s) 602 may include communication lines, or ports to enable the exchange of information with a network and/or other computing platforms. Illustration of the computing platform(s) 602 in FIG. 6 is not intended to be limiting. The computing platform(s) 602 may include a plurality of hardware, software, and/or firmware components operating together to provide the functionality attributed herein to the computing platform(s) 602. For example, the computing platform(s) 602 may be implemented by a cloud of computing platforms operating together as the computing platform(s) 602.

Electronic storage 626 may include non-transitory storage media that electronically stores information. The electronic storage media of the electronic storage 626 may include one or both of system storage that is provided integrally (i.e., substantially non-removable) with computing platform(s) 602 and/or removable storage that is removably connectable to computing platform(s) 602 via, for example, a port (for example, a USB port, a firewire port, etc.) or a drive (for example, a disk drive, etc.). Electronic storage 626 may include one or more of optically readable storage media (for example, optical disks, etc.), magnetically readable storage media (for example, magnetic tape, magnetic hard drive, floppy drive, etc.), electrical charge-based storage media (for example, EEPROM, RAM, etc.), solid-state storage media (for example, flash drive, etc.), and/or other electronically readable storage media. Electronic storage 626 may include one or more virtual storage resources (for example, cloud storage, a virtual private network, and/or other virtual storage resources). Electronic storage 626 may store software algorithms, information determined by the processors 630, information received from computing platform(s) 602, information received from the remote platform(s) 604, and/or other information that enables the computing platform(s) 602 to function as described herein.

Processor(s) 630 may be configured to provide information processing capabilities in computing platform(s) 602. As such, processor(s) 630 may include one or more of a digital processor, an analog processor, a digital circuit designed to process information, an analog circuit designed to process information, a state machine, and/or other mechanisms for electronically processing information. Although processor(s) 630 is shown in FIG. 6 as a single entity, this is for illustrative purposes only. In some implementations, processor(s) 630 may include a plurality of processing units. These processing units may be physically located within the same device, or processor(s) 630 may represent processing functionality of a plurality of devices operating in coordination. Processor(s) 630 may be configured to execute modules 608, 610, 612, 614, 616, 618, 620, 622 and/or 624, and/or other modules. Processor(s) 630 may be configured to execute modules 608, 610, 612, 614, 616, 618, 620, 622 and/or 624, and/or other modules by software; hardware; firmware; some combination of software, hardware, and/or firmware; and/or other mechanisms for configuring processing capabilities on processor(s) 630. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 608, 610, 612, 614, 616, 618, 620, 622 and/or 624 are illustrated in FIG. 6 as being implemented within a single processing unit, in implementations in which processor(s) 630 includes multiple processing units, one or more of modules 608, 610, 612, 614, 616, 618, 620, 622 and/or 624 may be implemented remotely from the other modules. The description of the functionality provided by the different modules 608, 610, 612, 614, 616, 618, 620, 622 and/or 624 described below is for illustrative purposes, and is not intended to be limiting, as any of modules 608, 610, 612, 614, 616, 618, 620, 622 and/or 624 may provide more or less functionality than is described. For example, one or more of modules 608, 610, 612, 614, 616, 618, 620, 622 and/or 624 may be eliminated, and some or all of its functionality may be provided by other ones of modules 608, 610, 612, 614, 616, 618, 620, 622 and/or 624. As another example, processor(s) 630 may be configured to execute one or more additional modules that may perform some or all of the functionality attributed below to one of modules 608, 610, 612, 614, 616, 618, 620, 622 and/or 624.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

### Homomorphic Encryption Process

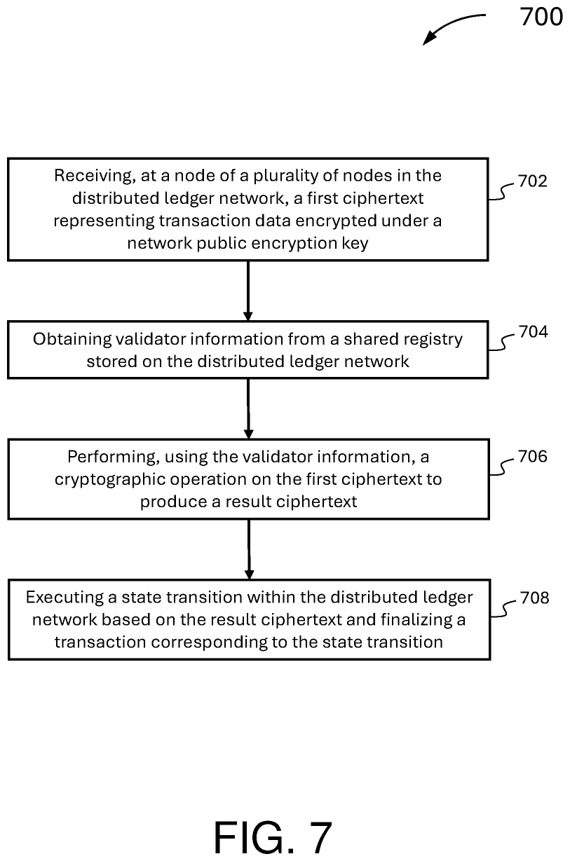

FIG. 7 illustrates a flowchart of an exemplary computer-implemented method 700 for performing confidential computation on encrypted data in a distributed ledger network, according to some embodiments.

At operation 702, method 700 includes receiving, at a node of a plurality of nodes in the distributed ledger network, a first ciphertext representing transaction data encrypted under a network public encryption key.

At operation 704, method 700 includes obtaining validator information from a shared registry stored on the distributed ledger network. The validator information may include validator identities, public keys, stake weights, and threshold participation parameters used to coordinate distributed cryptographic operations.

At operation 706, method 700 includes performing, using the validator information, a cryptographic operation on the first ciphertext to produce a result ciphertext. The cryptographic operation may include at least one of a homomorphic operation or an interactive multiparty computation executed among the plurality of nodes.

At operation 708, method 700 includes executing a state transition within the distributed ledger network based on the result ciphertext and finalizing a transaction corresponding to the state transition. In some embodiments, the state transition may update encrypted state variables and be applied atomically within the distributed ledger.

According to embodiments, method 700 may further include generating, by each node in the plurality of nodes, shares based on respective secret keys, deriving the network public encryption key by aggregating the shares, and distributing the network public encryption key to the plurality of nodes.

According to embodiments, method 700 may further include encrypting transaction data representing a value transfer between accounts using the network public encryption key prior to receiving the first ciphertext.

According to embodiments, method 700 may further include generating a re-linearization key based on shares derived from secret keys of the plurality of nodes and distributing the re-linearization key to the plurality of nodes, wherein the re-linearization key is configured to reduce a degree of a ciphertext resulting from a homomorphic multiplication operation.

According to embodiments, method 700 may further include performing a homomorphic operation on the first ciphertext to produce a second ciphertext and applying the re-linearization key to the second ciphertext to reduce a degree of the second ciphertext.

According to embodiments, method 700 may further include, upon receiving the transaction data, verifying a zero-knowledge proof to confirm that the first ciphertext was correctly encrypted under the network public encryption key.

According to embodiments, method 700 may further include converting secret keys of a subset of the plurality of nodes into threshold secret key shares using pairwise communication among the subset of nodes, wherein aggregation of the threshold secret key shares represents a threshold key, and distributing the threshold secret key shares among the plurality of nodes to enable any subset of at least a threshold number of nodes to perform decryption operations.

According to embodiments, method 700 may further include signing protocol messages exchanged between validator nodes using respective secret keys, storing the signed protocol messages and corresponding signatures, and executing a cryptographic operation audit using the stored signed protocol messages.

According to embodiments, method 700 may further include detecting a change in the plurality of nodes resulting in a modified validator set, generating modified threshold secret key shares based on secret keys of at least a threshold number of validator nodes from the modified validator set, and re-distributing the modified threshold secret key shares among the modified validator set, wherein the network public encryption key remains unchanged. In some embodiments, the protocol includes a key resharing mechanism configured to support dynamic changes in the validator set. Method 700 may include, when validators join or leave the network, triggering the key resharing mechanism where fresh threshold key shares may be generated and redistributed without altering the network public key. This resharing process enables continuity of encrypted state without requiring re-encryption of existing on-chain ciphertexts.

According to embodiments, the cryptographic operation performed at operation 706 may include performing FHE operations on the first ciphertext, including one or more of homomorphic addition, homomorphic subtraction, homomorphic multiplication, or bootstrapping, to produce the result ciphertext. In some embodiments, method 700 includes encrypting the first ciphertext using a GBFV scheme which supports packing of multiple integer values into a single ciphertext, thereby improving bandwidth efficiency and computational throughput for batched encrypted operations.

According to embodiments, the cryptographic operation performed at operation 706 may include executing interactive multiparty computation sub-routines among the plurality of nodes to perform non-arithmetic operations including comparison, equality determination, division, or interactive bootstrapping on the first ciphertext.

According to embodiments, method 700 may include digitally signing protocol messages exchanged among validators during MPC procedures using validator-specific secret keys. Signed messages and associated transcripts may be stored in validator storage to enable auditability, non-repudiation, and accountability in the event of disputes or malicious behavior.

The techniques described herein (for example, method 700) may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

In some implementations, one or more operation blocks of FIG. 7 may be performed by a processor circuit executing instructions stored in a memory circuit, in a client device, a remote server or a database, communicatively coupled through a network (for example, processors 205, memories 220, participant 110, participant 130, database(s) 152, and network 150).

Although FIG. 7 shows example blocks of method 700, in some implementations, the method 700 may include additional blocks, fewer blocks, different blocks, or differently arranged blocks than those depicted in FIG. 7.

### Hardware Overview

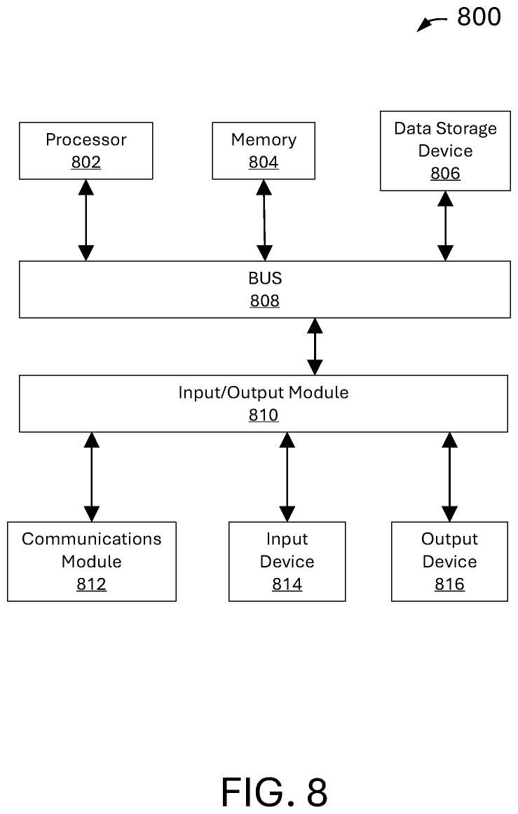

FIG. 8 is a block diagram illustrating an exemplary computer system 800 with which aspects of the subject technology can be implemented. In certain aspects, the computer system 800 may be implemented using hardware or a combination of software and hardware, either in a dedicated server, integrated into another entity, or distributed across multiple entities.

The computer system 800 (for example, server and/or participant) includes a bus 808 or other communication mechanism for communicating information, and a processor 802 (for example, processors 205) coupled with the bus 808 for processing information. By way of example, the computer system 800 may be implemented with one or more processors 802. Each of the one or more processors 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 800 can include, in addition to hardware, code that creates an execution environment for the computer program in question, for example, code that constitutes processor firmware, a protocol stack, a database management system, an operating system, or a combination of one or more of them stored in an included memory 804, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. Processor 802 and memory 804 can be supplemented by, or incorporated in, special purpose logic circuitry.

The instructions may be stored in memory 804 and implemented in one or more computer program products, i.e., one or more modules of computer program instructions encoded on a computer-readable medium for execution by, or to control the operation of, the computer system 800, and according to any method well-known to those of skill in the art, including, but not limited to, computer languages such as data-oriented languages (for example, SQL, dBase), system languages (for example, C, Objective-C, C++, Assembly), architectural languages (for example, Java, .NET), and application languages (for example, PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by the processor 802.

A computer program as discussed herein does not necessarily correspond to a file in a file system. A program can be stored in a portion of a file that holds other programs or data (for example, one or more scripts stored in a markup language document), in a single file dedicated to the program in question, or in multiple coordinated files (for example, files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 800 further includes a data storage device 806 such as a magnetic disk or optical disk, coupled to bus 808 for storing information and instructions. The computer system 800 may be coupled via input/output module 810 to various devices. The input/output module 810 can be any input/output module. Exemplary input/output modules 810 include data ports such as USB ports. The input/output module 810 is configured to connect to a communications module 812. Exemplary communications modules 812 include networking interface cards, such as Ethernet cards and modems. In certain aspects, the input/output module 810 is configured to connect to a plurality of devices, such as an input device 814 and/or an output device 816. Exemplary input devices 814 include a keyboard and a pointing device, for example, a mouse or a trackball, by which a user can provide input to the computer system 800. Other kinds of input devices can be used to provide for interaction with a user as well, such as a tactile input device, visual input device, audio input device, or brain-computer interface device. For example, feedback provided to the user can be any form of sensory feedback, for example, visual feedback, auditory feedback, or tactile feedback, and input from the user can be received in any form, including acoustic, speech, tactile, or brain wave input. Exemplary output devices 816 include display devices such as an LCD (liquid crystal display) monitor, for displaying information to the user.

According to one aspect of the present disclosure, the above-described systems can be implemented using a computer system 800 in response to the processor 802 executing one or more sequences of one or more instructions contained in the memory 804. Such instructions may be read into memory 804 from another machine-readable medium, such as data storage device 806. Execution of the sequences of instructions contained in the main memory 804 causes the processor 802 to perform the process steps described herein. One or more processors in a multi-processing arrangement may also be employed to execute the sequences of instructions contained in the memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, for example, such as a data server, or that includes a middleware component, for example, an application server, or that includes a front end component, for example, a client computer having a graphical user interface or a Web browser through which a user can interact with an implementation of the subject matter described in this specification, or any combination of one or more such back end, middleware, or front end components. The components of the system can be interconnected by any form or medium of digital data communication, for example, a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 800 can include clients and servers. A client and server are generally remote from each other and typically interact through a communication network. The relationship of client and server arises by virtue of computer programs running on the respective computers and having a client-server relationship to each other. The computer system 800 can be, for example, and without limitation, a desktop computer, laptop computer, or tablet computer. The computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 802 for execution. Such a medium may take many forms, including, but not limited to, non-volatile media, volatile media, and transmission media. Non-volatile media include, for example, optical or magnetic disks, such as the data storage device 806. Volatile media include dynamic memory, such as the memory 804. Transmission media include coaxial cables, copper wire, and fiber optics, including the wires that comprise the bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (for example, one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (for example, DVD-ROM, dual-layer DVD-ROM), a variety of recordable/rewritable DVDs (for example, DVD-RAM, DVD-RW, DVD+RW, etc.), flash memory (for example, SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network. While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize user privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the user's privacy settings or preferences. It should also be understood that the original applicant intends that the systems and methods described herein, if implemented or used by other entities, be in compliance with privacy policies and practices that are consistent with its objective to respect the user's privacy.

What is claimed is:

1. A method for performing confidential computation on encrypted data, the method comprising:
receiving, at a node of a plurality of nodes in a distributed ledger network, a first ciphertext representing transaction data encrypted under a network encryption public key;
obtaining validator information from a shared registry stored on the distributed ledger network;
performing, using the validator information, a cryptographic operation on the ciphertext to produce a result ciphertext, wherein the cryptographic operation comprises a homomorphic operation and/or an interactive multiparty computation executed among the plurality of nodes; and
executing a state transition within the distributed ledger network based on the result ciphertext and finalizing a transaction corresponding to the state transition.

2. The computer-implemented method of claim 1, further comprising:
generating, by each node in the plurality of nodes, shares based on respective secret keys;
deriving the network encryption public key by aggregating the shares generated by the plurality of nodes; and
distributing the network encryption public key to the plurality of nodes.

3. The computer-implemented method of claim 1, further comprising encrypting transaction data representing a value transfer between accounts using the network encryption public key.

4. The computer-implemented method of claim 1, further comprising:
generating a re-linearization key based on shares derived from secret keys of a plurality of nodes; and
distributing the re-linearization key to the plurality of nodes, wherein the re-linearization key is configured to reduce a degree of a ciphertext resulting from a homomorphic multiplication operation performed on encrypted data under the network public encryption key.

5. The computer-implemented method of claim 1, further comprising:
performing a homomorphic operation on the first ciphertext to produce a second ciphertext; and
applying the re-linearization key to the second ciphertext to reduce a degree of the second ciphertext.

6. The computer-implemented method of claim 1, further comprising upon receiving the transaction data, verifying a zero-knowledge proof to confirm that the first ciphertext was correctly encrypted under the network encryption public key.

7. The computer-implemented method of claim 1, further comprising:
converting secret keys of a subset of the plurality of nodes into threshold secret key shares individually held by the plurality of nodes using pairwise communication among the subset of nodes, wherein the aggregation of the threshold secret key shares represents a threshold key; and
distributing the threshold secret key shares among the plurality of nodes, wherein the threshold secret key shares enable any subset of at least a threshold number of nodes from the plurality of nodes to perform decryption operations on encrypted data encrypted under the network public encryption key.

8. The computer-implemented method of claim 1, further comprising:
signing protocol messages exchanged between a validator node and at least one other node of the plurality of nodes using a secret key of the validator node;
storing the signed protocol message and corresponding signatures to enable subsequent auditing of cryptographic operations; and
executing a cryptographic operation audit using the stored signed protocol messages.

9. The computer-implemented method of claim 1, further comprising:
detecting a change in the plurality of nodes resulting in a modified validator set, the change including at least one of an entry of a new validator node or removal of an existing validator node;
generating modified threshold secret key shares based on secret keys of at least a threshold number of validator nodes from the modified validator set; and
re-distributing the modified threshold secret key shares among the modified validator set, wherein the network encryption public key remains unchanged during the re-distributing based on the updated validator set.

10. The computer-implemented method of claim 1, wherein the cryptographic operation comprises performing Fully Homomorphic Encryption (FHE) operations on the first ciphertext, including at least one of homomorphic addition, homomorphic subtraction, homomorphic multiplication, or bootstrapping, to produce the result ciphertext.

11. The computer-implemented method of claim 1, wherein the cryptographic operation comprises executing interactive multiparty computation sub-routines among the plurality of nodes to perform at least one non-arithmetic operation comprising of comparison, equality determination, division, and interactive bootstrapping on the first ciphertext.

12. A system for performing confidential computation on encrypted data in a distributed ledger network, comprising:
one or more processors; and
a memory comprising instructions stored thereon, which when executed by the one or more processors, causes the one or more processors to:
receive, at a node of a plurality of nodes in the distributed ledger network, a first ciphertext representing transaction data encrypted under a network encryption public key;
obtain validator information from a shared registry stored on the distributed ledger network;
perform, using the validator information, a cryptographic operation on the first ciphertext to produce a result ciphertext, wherein the cryptographic operation comprises a homomorphic operation and/or an interactive multiparty computation executed among the plurality of nodes; and
execute a state transition within the distributed ledger network based on the result ciphertext and finalize a transaction corresponding to the state transition.

13. The system of claim 12, wherein the instructions further cause the one or more processors to:
generate, by each node in the plurality of nodes, shares based on respective secret keys;
derive the network encryption public key by aggregating the shares generated by the plurality of nodes; and
distribute the network encryption public key to the plurality of nodes.

14. The system of claim 12, wherein the instructions further cause the one or more processors to encrypt transaction data representing a value transfer between accounts using the network encryption public key.

15. The system of claim 12, wherein the instructions, when executed by at least one of the one or more processors, further causes the system to:
generate a re-linearization key based on shares derived from secret keys of the plurality of nodes;
distribute the re-linearization key to the plurality of nodes, wherein the re-linearization key is configured to reduce a degree of a ciphertext resulting from a homomorphic multiplication operation performed on encrypted data under the network encryption public key;
perform a homomorphic operation on the first ciphertext to produce a second ciphertext; and
apply the re-linearization key to the second ciphertext to reduce a degree of the second ciphertext.

16. The system of claim 12, wherein the instructions further cause the one or more processors to:
convert secret keys of a subset of the plurality of nodes into threshold secret key shares individually held by the plurality of nodes using pairwise communication among the subset of nodes, wherein aggregation of the threshold secret key shares represents a threshold key; and
distribute the threshold secret key shares among the plurality of nodes, wherein the threshold secret key shares enable any subset of at least a threshold number of nodes from the plurality of nodes to perform decryption operations on encrypted data encrypted under the network encryption public key.

17. The system of claim 12, wherein the instructions further cause the one or more processors to:
sign protocol messages exchanged between a validator node and at least one other node of the plurality of nodes using a secret key of the validator node;
store the signed protocol messages and corresponding signatures to enable subsequent auditing of cryptographic operations; and
execute a cryptographic operation audit using the stored signed protocol messages.

18. The system of claim 12, wherein the instructions further cause the one or more processors to:
detect a change in the plurality of nodes resulting in a modified validator set, the change including at least one of entry of a new validator node or removal of an existing validator node;
generate modified threshold secret key shares based on secret keys of at least a threshold number of validator nodes from the modified validator set; and
re-distribute the modified threshold secret key shares among the modified validator set, wherein the network encryption public key remains unchanged during the re-distributing based on the modified validator set.

19. The system of claim 12, wherein the instructions further cause the one or more processors to:
perform Fully Homomorphic Encryption (FHE) operations on the first ciphertext, including at least one of homomorphic addition, homomorphic subtraction, homomorphic multiplication, or bootstrapping, to produce the result ciphertext; and
execute interactive multiparty computation sub-routines among the plurality of nodes to perform at least one non-arithmetic operation comprising comparison, equality determination, division, or interactive bootstrapping on the first ciphertext.

20. A non-transitory computer-readable medium storing a program for implementing secure transfers in a distributed ledger system, which when executed by a computer, configures the computer to:
receive, at a node of a plurality of nodes in the distributed ledger network, a first ciphertext representing transaction data encrypted under a network encryption public key;
obtain validator information from a shared registry stored on the distributed ledger network;
perform, using the validator information, a cryptographic operation on the first ciphertext to produce a result ciphertext, wherein the cryptographic operation comprises a homomorphic operation and/or an interactive multiparty computation executed among the plurality of nodes; and
execute a state transition within the distributed ledger network based on the result ciphertext and finalize a transaction corresponding to the state transition.
